(19) United States
(12) Patent Application Publication
(10) Pub. No.: US 2013/0006785 A1
(43) Pub. Date: Jan. 3, 2013

(54) SYSTEM AND METHOD TO FACILITATE SETTLEMENT OF A TRANSACTION

(76) Inventors: Richard Scott Perkins, Meridian, ID (US); Barry Donald McKeon, Felton, CA (US); John Paul Minor, Brick, NJ (US); Kurt Thams, Santa Cruz, CA (US)

(21) Appl. No.: 13/175,657

(22) Filed: Jul. 1, 2011

(51) Int. Cl. G06Q 20/00

(52) U.S. Cl. 705/18; 705/21

(57) ABSTRACT

Disclosed herein are systems and method for facilitating transactions between a merchant-partner and an end-user (e.g., a customer of the merchant-partner). More specifically, presented herein are systems and methods for settling a transaction between a point-of-sale terminal and a merchant-partner, wherein the point-of-sale terminal receives presentment of a payment for the merchant-partner from an end-user.

### SUMMARY

Disclosed herein are systems and methods for facilitating transactions between a merchant-partner and an end-user (e.g., a customer of the merchant-partner). More specifically, presented herein are systems and methods for settling a transaction between a point-of-sale terminal and a merchant-partner, wherein the point-of-sale terminal receives presentment of a payment for the merchant-partner from an end-user. In one embodiment, the method generally includes: (a) receiving confirmation that an end-user has presented, to a point-of-sale terminal, a payment for a merchant-partner; (b) authorizing the point-of-sale terminal to accept the payment from the end-user; (c) creating a funding record identifying a funding amount expected to be received from the point-of-sale terminal; (d) receiving funds from the point-of-sale terminal; (e) confirming that the funds received in step (d) match the funding amount expected from step (c); and (f) generating an outbound cash-flow to the merchant-partner to settle the transaction. The recited steps may be performed in sequence or in any order that is deemed appropriate. However, in one embodiment, step (f) is performed only after the confirmation of step (e).

Aspects of the present invention are particularly useful in providing merchants (e.g., web-based or catalog-based merchants) with a means for conducting fast, easy, and secure cash transactions with consumers. The present invention is also particularly useful in facilitating cash transactions such as: loan repayments, collections, money transfers, bill payments, remote deposits, etc.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a high-level flow process chart illustrating the relationships between the parties that partake in the presented systems and methods.

FIG. 2 is a high-level flowchart illustrating a method for facilitating transactions, in accordance with one embodiment presented herein.

FIG. 3 is a flowchart illustrating an aspect of the method of FIG. 2.

FIG. 4 is a high-level process chart illustrating one aspect of the present invention.

FIG. 5 is a flowchart illustrating one embodiment of the present invention.

FIG. 6 is a schematic drawing of a computer system used to implement the methods presented herein.

### DETAILED DESCRIPTION

The present application is related to co-pending and co-owned U.S. application Ser. Nos. 13/123,067 and 13/087,271, filed Apr. 7, 2011, and Apr. 14, 2011, respectively; the disclosures of which are herein incorporated by reference in their entirety. For example, U.S. application Ser. No. 13/087,271 discloses systems and methods that generally include: (a) staging a transaction between a merchant and a customer; (b) tokenizing the transaction by linking one or more transaction instructions to a token ID; (c) providing the customer with the token ID, wherein the customer can then present the token ID and a payment to a point-of-sale (POS) terminal; (d) receiving confirmation that the customer has presented, to the POS terminal, the token ID and a payment in accordance with the one or more transaction instructions; (e) notifying the merchant that the customer provided the payment to the POS terminal; and (f) settling the transaction between the POS terminal and the merchant. The systems and methods presented herein expand on and further develop the settlement process presented in U.S. application Ser. Nos. 13/123,067 and 13/087,271.

Before describing the invention in more detail, it is appropriate to define certain terms and phrases. The terms “merchant” and “merchant-partner” are used interchangeably herein. It is noted that the term “merchant” and/or “merchant-partner” is not limited to entities that directly sell goods/services. For example, a merchant may be a loan service, collections service, money transfer service, bill payment service, bank deposit service, credit union, etc. The terms “consumer,” “customer,” and “end-user” are used interchangeably herein. However, it is noted that the use of the systems and methods presented is not limited to sale/purchase transactions between a seller and a buyer. The systems and methods presented may be used to facilitate transactions between: two individuals, an individual and a business, two businesses, etc. The systems and methods presented may also be used to facilitate transactions between any two parties that have a pre-existing relationship or obligation(s). The terms “point-of-sale,” “point-of-sale terminal,” “POS,” “POS terminal,” and “point-of-payment” are used interchangeably herein. It is also noted that terms such as “POS” or “POS terminal” may include the actual terminal where payment is presented and received (e.g., the cash register), or may include the POS back office or any entity controlling one or more of the actual terminals. The terms “service provider” and “payment processor” are used interchangeably herein.

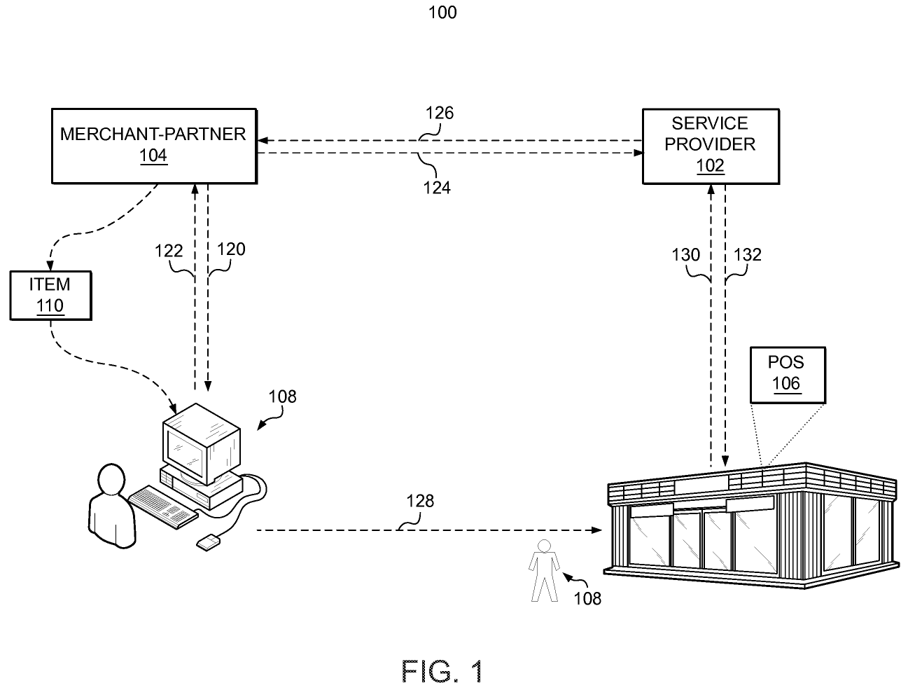

The following is a description of one or more embodiments of the present invention, with reference to FIGS. 1-6. It is to be understood that the present invention is not limited to the particular embodiments described. It is also to be understood that the terminology used herein is for the purpose of describing particular embodiments only, and is not intended to be limiting, since the scope of the present invention will be limited only by the appended claims.

Embodiments of the present invention generally relate to systems and methods for facilitating transactions between a merchant-partner and a customer. For example, the present invention provides a merchant-partner with a means for conducting a cash transaction via a remote POS terminal. The present invention is particularly useful in facilitating transactions such as: sale/purchase agreements, loan repayments, collections, money transfers, bill payments, remote deposits, etc.

In one embodiment, a service provider and/or POS terminal serves as an intermediary between a merchant-partner and the customer. The system allows the customer to pay for the merchant-partner's goods/services in cash (or cash equivalents) at a POS terminal. The POS terminal and/or service provider then notifies the merchant that the customer has made a payment. After the merchant-partner has received a notification, validation, or otherwise confirmation of payment, the merchant-partner can securely complete the agreed upon transaction between the merchant-partner and the customer.

However, in order for such system to be commercially viable, the systems and methods presented generally include the process steps of: (a) staging a transaction between the merchant and the customer; (b) tokenizing the transaction by linking one or more transaction instructions to a token ID; (c) providing the customer with the token ID, wherein the customer can then present the token ID and a payment to a POS terminal; (d) receiving confirmation that the customer has presented, to a POS terminal, the token ID and a payment in accordance with the one or more transaction instructions; (e) notifying the merchant that the customer provided the payment to the POS terminal; and (f) settling the transaction between the POS terminal and the merchant.

FIG. 1 is a high-level flow process chart, illustrating the relationships between the parties that partake in the presented system 100. In general, system 100 includes four key parties: (1) service provider 102; (2) merchant-partner 104; (3) point-of-sale (POS) 106; and (4) end-user 108. The dashed lines in FIG. 1 generally represent a flow of information, data, or process between respective parties. In practice, the dashed lines in FIG. 1 represent user interfaces and/or application program interfaces (APIs) for the transmission of information, data, instructions, funds, etc.

As will be described further below, service provider 102 and POS 106 play a central role in facilitating transactions between merchant-partner 104 and end-user 108. In one embodiment, each party serves a stand-alone function within system 100. However, in an alternative embodiment, service provider 102 may be incorporated into, or be a functional unit of, merchant-partner 104 and/or POS 106. Further, merchant-partner 104 may be any type of merchant, seller, or retailer; such as an online, web-based merchant, or catalog-based merchant. POS 106 may be a local retailer (e.g., relative to end-user 108), ATM, kiosk, or other cash-exchange terminal, intermediary, or equivalent thereof.

In FIG. 1, process flow 120 and 122 represents an exchange between merchant-partner 104 and end-user 108. In the example shown, merchant-partner 104 provides end-user 108 with a user-interface to purchase a goods/services. For example, the merchant may provide the user with a “checkout” experience over: a webpage on a merchant's website; an interface on a mobile device; an interactive voice system over a telephone network; or any interface equivalent thereto. While known customer user-interfaces may provide a “checkout” experience that allows an end-user to enter their credit card information, the system shown in FIG. 1 provides the end-user with a checkout experience that allows the end-user to pay for the goods/services in cash (or cash equivalents).

If the end-user selects to pay in cash, then merchant-partner 104 interfaces and exchanges information with service provider 102, as represented by process flow 124, 126. In practice, merchant-partner 104 and/or service provider 102 stages a transaction by linking a set of one or more transaction instructions to end-user 108. The transaction instructions may vary, but generally include instructions on what actions (e.g., payments) need to be performed by end-user 108 in order for merchant-partner 104 to provide end-user 108 with the agreed upon goods/services (e.g., item 110). The transaction instructions may include actions to be performed by the end-user 108, merchant-partner 104, service provider 102, or any combination thereof.

Service provider 102 then “tokenizes” the staged transaction by linking the set of one or more transaction instructions to a token ID. (The terms “token,” “token ID,” “unique payment identifier,” and “PID” are used interchangeably herein.) In an alternative embodiment, a single token ID can be linked to multiple staged transactions and/or multiple merchant-partners. The token ID is then provided to end-user 108. The token ID can be provided to the end-user 108 either directly from service provider 102, or via POS 106 or merchant-partner 104. When end-user 108 is ready to make a payment, end-user 108 presents the token ID to POS 106, along with an appropriate payment, as represented by process flow 128. At POS 106, the token ID serves as a means of linking the end-user's payment to the one or more transaction instructions.

When end-user 108 presents the token ID and payment to POS 106, the token ID is used to route the presentment information to service provider 102, as represented by process flow 130, 132. Service provider 102 may then validate that the presentment was in accordance with the transaction instructions linked to the token ID. If the end-user's payment is in accordance with the transaction instructions linked to the token ID, then service provider 102 notifies merchant-partner 104 that a payment has been made. Merchant-partner 104 then completes the transaction by, for example, shipping item 110 or otherwise fulfilling the transaction and/or crediting end-user's 108 account with merchant-partner 104. Service provider 102 then settles the transaction between merchant-partner 104 and POS 106 by receiving the payment funds (minus any agreed upon service fees) from POS 106, and delivering the payment funds (minus any agreed upon service fees) to merchant-partner 104.

In an alternative embodiment, the systems and methods described herein do not require merchant-partner 104 to provide end-user 108 with a checkout experience. There is also no requirement that the end-user provide an intent or selection of a cash payment option. For example, in one embodiment, merchant-partner 104 provides its customers with one or more tokens as a means for the customers to make payments. The payments can be made at a POS terminal, and a series of staged transactions may proceed, without any front-end involvement by the end-user.

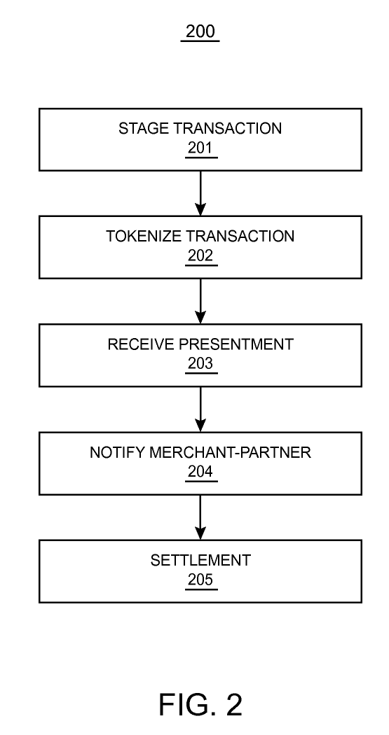

FIG. 2 is a high-level flowchart illustrating a method 200 for facilitating a transaction between a merchant and a customer, in accordance with one embodiment presented herein. More specifically, FIG. 2 is a flowchart generally illustrating the steps performed in the system described in FIG. 1. The method includes: (a) staging a transaction (step 201); (b) tokenizing the staged transaction (step 202); (c) receiving the presentment (step 203); (d) notifying the merchant-partner that the presentment has been received (step 204); and (e) settling the transaction between the parties (step 205). Additional details for steps (a)-(d) are provided in U.S. application Ser. Nos. 13/123,067 and 13/087,271.

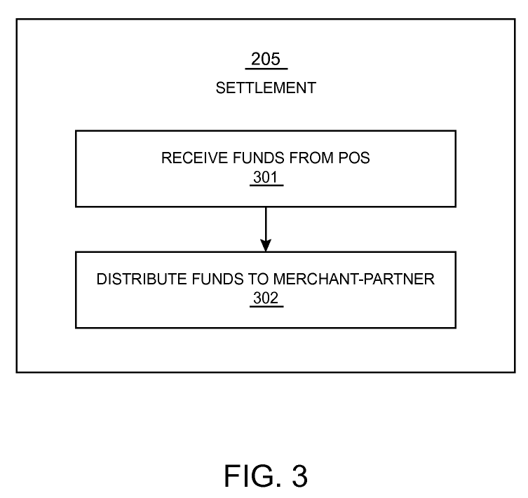

FIG. 3 is a flowchart illustrating the steps of settlement 205, in accordance with one embodiment. In step 301, the service provider receives funds from the POS terminal. In step 302, the service provider distributes funds to the merchant-partner. In an alternative embodiment, the steps may be reversed in order to meet the settlement requirements of the various parties. The timing of the performance of steps 301 and 302 can also be modified in accordance with the settlement requirements of the various parties. Further, the service provider may adjust the amounts received and/or distributed in accordance with a contractual agreement between the parties. As used herein the phrases “receive funds from POS terminal” and “distribute funds to the merchant-partner” do not require direct communications/transfers between individual entities. Settlement also does not require the actual “touching” of funds. For example, as used herein, to “settle the transaction between the point-of-sale terminal and the merchant-partner” means to: transfer funds; direct funds; provide an interface for the transfer of funds; and/or otherwise provide the necessary instructions to make sure the funds are properly directed from one entity to another. Further, to “settle the transaction between the point-of-sale terminal and the merchant-partner” includes communications/transfer with any and all centralized or hierarchical entities that receive funds from individual POS terminals and/or POS back offices at the closing of a defined time period (e.g., a banking day).

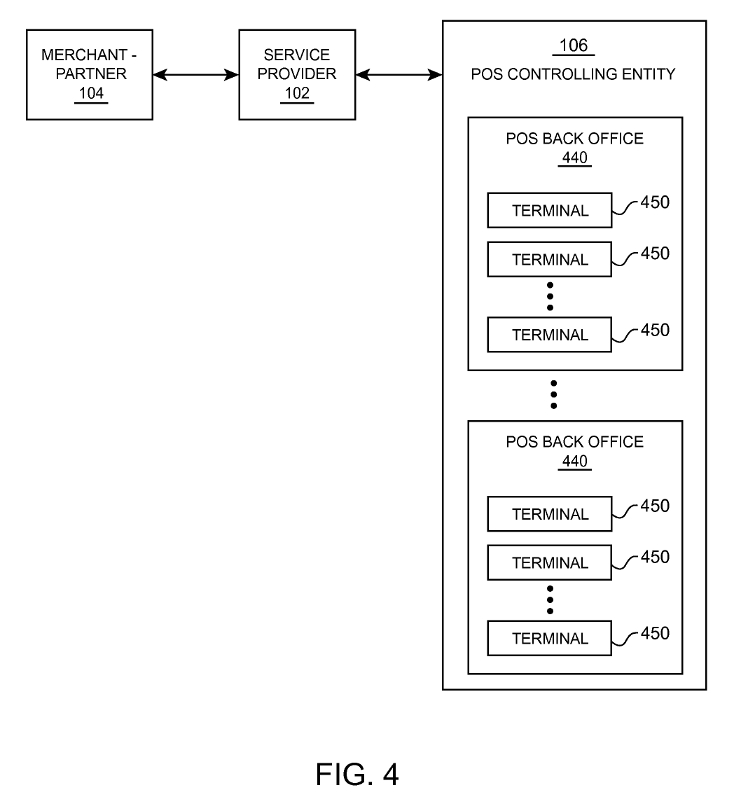

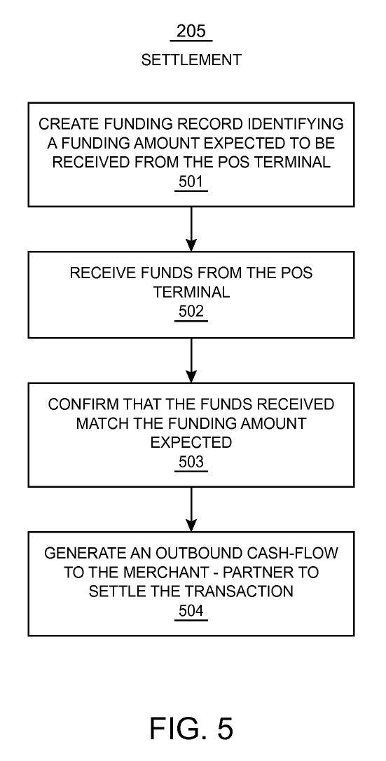

FIGS. 4 and 5 illustrate an alternative embodiment of the settlement process.

FIG. 4 illustrates how, in principle, there is a linear relationship between merchant-partner 104, service provider 102, and POS 106. In practice, however, POS 106 is a centralized controlling entity overseeing a plurality of POS back offices 440. Each POS back office, in turn, controls a plurality of terminals (e.g., cash registers) 450 where end-users 108 present payment. Because of the variability in (a) when a terminal 450 is officially “closed” or “reconciled” for a given time-period and (b) when a back office 440 is officially closed or reconciled for a given time-period, there is a significant amount of variability in when the actual funds for a particular transaction are pushed up from a terminal 450, through the POS 106 system, and out to service provider 102. In other words, rarely will service provider 102 receive funds from POS 106 in chronological or matching order with respect to received presentment data. As such, a settlement process at service provider 102 was engineered to deal with the randomness of terminal 450 closings and back office 440 closings.

FIG. 5 is a flowchart illustrating one embodiment of the settlement process 205.

In step 501, a funding record is created to identify a funding amount expected to be received from the POS terminal (or POS 106 generally). For example, service provider 102 may maintain a database with records identifying the presentment data for each transaction processed through POS terminal 450. Each presentment data point will thus have a respective funding amount expected. In step 502, funds are received from the POS terminal. As mentioned above, the randomness of terminal closings and back office closings creates randomness in the order for which funds are actually received at service provider 102. As such, funds received must be reconciled with the funding amounts expected. In one embodiment, funds are received from POS 106 with a line-item detail file identifying the specific transactions that are actually being funded. In step 503, service provider 102 reconciles and/or confirms that the funds received match the funding amounts expected. In other words, service provider 102 tests the line-item detail file received from POS 106 against the funding records of step 501. As such, service provider 102 can identify which transactions have been actually funded, and thus which transactions should be paid to merchant-partner 104. In step 504, an outbound cash-flow is generated to merchant-partner 104 to settle the funded transactions. In one embodiment, step 504 is performed only after step 503.

### Additional Embodiments

In one embodiment, there is provide a method of settling a transaction between a

POS terminal and a merchant-partner, wherein the POS terminal receives presentment of a payment for the merchant-partner from an end-user, the method comprising: (a) receiving confirmation that an end-user has presented, to a POS terminal, a payment for a merchant-partner; (b) authorizing the POS terminal to accept the payment from the end-user; (c) creating a funding record identifying a funding amount expected to be received from the POS terminal; (d) receiving funds from the POS terminal; (e) confirming that the funds received in step (d) match the funding amount expected from step (c); and (f) generating an outbound cash-flow to the merchant-partner to settle the transaction. Step (f) may be performed only after step (e). Step (c) may be performed before step (b). The method may further comprise: (1) asserting to the merchant-partner what amount is owed to the merchant-partner; and/or (2) asserting to the merchant-partner when the amount owed will be released to the merchant-partner. The method may further comprise, after step (c): (1) receiving a line-item detail file from the POS terminal; and (2) reconciling the line-item detail file with the created funding record. The line-item detail file may be a non-chronological database of POS terminal transactions. Step (d) of the method may further comprise, receiving funds from the POS terminal via a centralized controlling entity, wherein the centralized controlling entity serves as a transaction hub for a plurality of POS terminals.

In still another embodiment, there is provided a method of facilitating a transaction, the method comprising: (a) tokenizing a transaction by linking one or more transaction instructions a token ID; (b) providing an end-user with the token ID; (c) receiving confirmation that the end-user has presented, to a POS terminal, the token ID and a payment in accordance with the one or more transaction instructions; (d) notifying a merchant-partner that the end-user has provided the payment to the POS terminal; and (e) settling the transaction between the POS terminal and the merchant-partner by (1) creating a funding record identifying a funding amount expected to be received from the POS terminal, (2) receiving funds from the POS terminal, (3) confirming that the funds received in step (2) match the funding amount expected from step (1), and (4) generating an outbound cash-flow to the merchant-partner to settle the transaction. Step (4) may be performed only after step (3). After step (c), the method may further comprises: (1) asserting to the merchant-partner what amount is owed to the merchant-partner; and/or (2) asserting to the merchant-partner when the amount owed will be released to the merchant-partner. Step (e) may further comprise: (1) receiving a line-item detail file from the POS terminal; and (2) reconciling the line-item detail file with the created funding record. The line-item detail file may be a non-chronological database of POS terminal transactions. Step (e)(2) may further include receiving funds from the POS terminal via a centralized controlling entity, wherein the centralized controlling entity serves as a transaction hub for a plurality of POS terminals.

### Computer Implementation

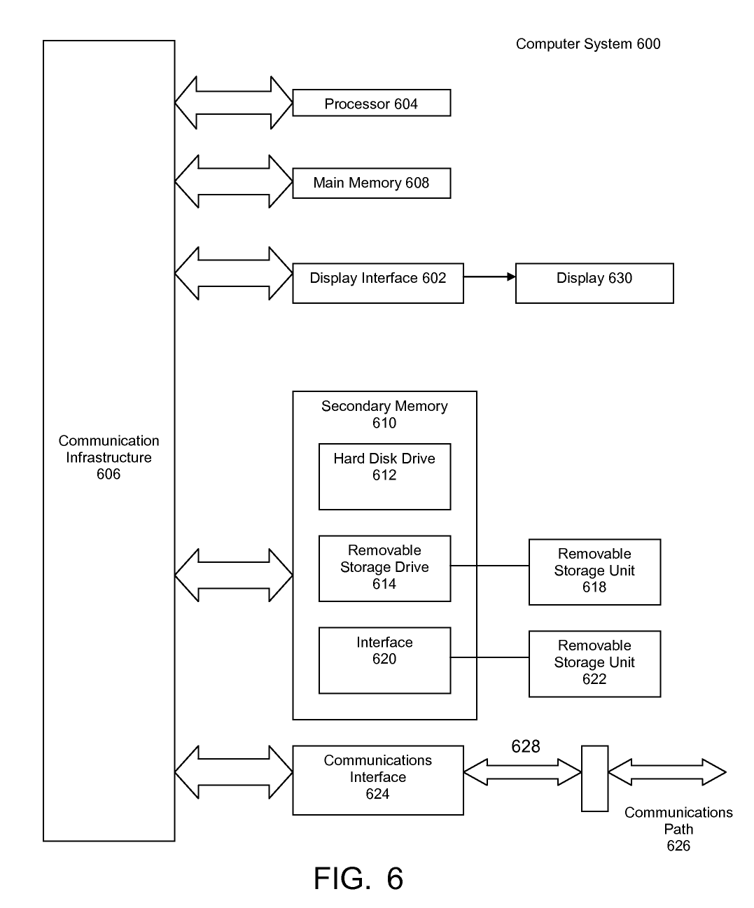

In one embodiment, the invention is directed toward one or more computer systems capable of carrying out the functionality described herein. For example, FIG. 6 is a schematic drawing of a computer system 600 used to implement the methods presented above. Computer system 600 includes one or more processors, such as processor 604. The processor 604 is connected to a communication infrastructure 606 (e.g., a communications bus, cross-over bar, or network). Computer system 600 can include a display interface 602 that forwards graphics, text, and other data from the communication infrastructure 606 (or from a frame buffer not shown) for display on a local or remote display unit 630.

Computer system 600 also includes a main memory 608, such as random access memory (RAM), and may also include a secondary memory 610. The secondary memory 610 may include, for example, a hard disk drive 612 and/or a removable storage drive 614, representing a floppy disk drive, a magnetic tape drive, an optical disk drive, flash memory device, etc. The removable storage drive 614 reads from and/or writes to a removable storage unit 618. Removable storage unit 618 represents a floppy disk, magnetic tape, optical disk, flash memory device, etc., which is read by and written to by removable storage drive 614. As will be appreciated, the removable storage unit 618 includes a computer usable storage medium having stored therein computer software, instructions, and/or data.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow computer software, instructions, and/or data to be transferred from the removable storage unit 622 to computer system 600.

Computer system 600 may also include a communications interface 624. Communications interface 624 allows computer software, instructions, and/or data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628 which may be electronic, electromagnetic, optical or other signals capable of being received by communications interface 624. These signals 628 are provided to communications interface 624 via a communications path (e.g., channel) 626. This channel 626 carries signals 628 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 614, removable storage units 618, 622, data transmitted via communications interface 624, and/or a hard disk installed in hard disk drive 612. These computer program products provide computer software, instructions, and/or data to computer system 600. These computer program products also serve to transform a general purpose computer into a special purpose computer programmed to perform particular functions, pursuant to instructions from the computer program products/software. Embodiments of the present invention are directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 604 to perform the features of the presented methods. Accordingly, such computer programs represent controllers of the computer system 600. Where appropriate, the processor 604, associated components, and equivalent systems and sub-systems thus serve as “means for” performing selected operations and functions. Such “means for” performing selected operations and functions also serve to transform a general purpose computer into a special purpose computer programmed to perform said selected operations and functions.

In an embodiment where the invention is implemented using software, the software may be stored in a computer program product and loaded into computer system 600 using removable storage drive 614, interface 620, hard drive 612, or communications interface 624. The control logic (software), when executed by the processor 604, causes the processor 604 to perform the functions and methods described herein.

In another embodiment, the methods are implemented primarily in hardware using, for example, hardware components such as application specific integrated circuits (ASICs) Implementation of the hardware state machine so as to perform the functions and methods described herein will be apparent to persons skilled in the relevant art(s). In yet another embodiment, the methods are implemented using a combination of both hardware and software.

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

For example, in one embodiment, there is provided a computer-readable storage medium, having instructions executable by at least one processing device that, when executed, cause the processing device to: (a) receive confirmation that an end-user has presented, to a POS terminal, a payment for a merchant-partner; (b) authorize the POS terminal to accept the payment from the end-user; (c) create a funding record identifying a funding amount expected to be received from the POS terminal; (d) receive a line-item detail file identifying funds delivered from the POS terminal; (e) reconcile the line-item detail file with the funding record of step (c); and (f) generate an outbound cash-flow to the merchant-partner to settle the transaction. The line-item detail file may be a non-chronological database of POS terminal transactions. The computer-readable storage medium may further include instructions executable by at least one processing device that, when executed, cause the processing device to (1) notify the merchant-partner of an amount that is owed to the merchant-partner; (2) notify the merchant-partner of when the amount owed will be released to the merchant-partner; and/or (3) receive funds from the POS terminal via a centralized controlling entity. The centralized controlling entity may serve as a transaction hub for a plurality of POS terminals.

In still another embodiment, there is provided a computer base system having: (a) means for receiving confirmation that an end-user has presented, to a POS terminal, a payment for a merchant-partner; (b) means for authorizing the POS terminal to accept the payment from the end-user; (c) means for creating a funding record identifying a funding amount expected to be received from the POS terminal; (d) means for receiving funds from the POS terminal; (e) means for confirming that the funds received match the funding amount expected; and (f) means for generating an outbound cash-flow to the merchant-partner to settle the transaction.

### Conclusion

It is noted that the figures, individually and/or collectively, serve as embodiments of the presented systems and methods. Each individual process or sub-process performed within the embodiments described can be performed by one or more parties, as well as one or more computer systems. For example, in one embodiment, some or all of the communications and data transfers between merchant, service provider, and POS terminal are performed via an automated computer-based system, such as an application program interface. Further, not all of the individual process or sub-process described are necessary for implementing the systems and methods described herein. As such, the embodiments presented in the figures are not intended to be limiting.

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

Unless defined otherwise, all technical and scientific terms used herein have the same meaning as commonly understood by one of ordinary skill in the art to which this invention belongs.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

What is claimed is:

1. A method of settling a transaction between a point-of-sale terminal and a merchant-partner, wherein the point-of-sale terminal receives presentment of a payment for the merchant-partner from an end-user, the method comprising:
(a) receiving confirmation that an end-user has presented, to a point-of-sale terminal, a payment for a merchant-partner;
(b) authorizing the point-of-sale terminal to accept the payment from the end-user;
(c) creating a funding record identifying a funding amount expected to be received from the point-of-sale terminal;
(d) receiving funds from the point-of-sale terminal;
(e) confirming that the funds received in step (d) match the funding amount expected from step (c); and
(f) generating an outbound cash-flow to the merchant-partner to settle the transaction.

2. The method of claim 1, wherein step (f) is performed only after step (e).

3. The method of claim 1, wherein step (c) is performed before step (b).

4. The method of claim 1, wherein after step (c), the method further comprises:
asserting to the merchant-partner what amount is owed to the merchant-partner.

5. The method of claim 4, further comprising:
asserting to the merchant-partner when the amount owed will be released to the merchant-partner.

6. The method of claim 1, wherein after step (c), the method further comprises:
receiving a line-item detail file from the point-of-sale terminal; and
reconciling the line-item detail file with the created funding record.

7. The method of claim 6, wherein the line-item detail file is a non-chronological database of point-of-sale terminal transactions.

8. The method of claim 1, wherein step (d) comprises:
receiving funds from the point-of-sale terminal via a centralized controlling entity, wherein the centralized controlling entity serves as a transaction hub for a plurality of point-of-sale terminals.

9. A computer-readable storage medium, comprising:
instructions executable by at least one processing device that, when executed, cause the processing device to
(a) receive confirmation that an end-user has presented, to a point-of-sale terminal, a payment for a merchant-partner;
(b) authorize the point-of-sale terminal to accept the payment from the end-user;
(c) create a funding record identifying a funding amount expected to be received from the point-of-sale terminal;
(d) receive a line-item detail file identifying funds delivered from the point-of-sale terminal;
(e) reconcile the line-item detail file with the funding record of step (c); and
(f) generate an outbound cash-flow to the merchant-partner to settle the transaction.

10. The computer-readable storage medium, of claim 9, further comprising:
instructions executable by at least one processing device that, when executed, cause the processing device to notify the merchant-partner of an amount that is owed to the merchant-partner.

11. The computer-readable storage medium, of claim 10, further comprising:
instructions executable by at least one processing device that, when executed, cause the processing device to notify the merchant-partner of when the amount owed will be released to the merchant-partner.

12. The computer-readable storage medium of claim 9, wherein the line-item detail file is a non-chronological database of point-of-sale terminal transactions.

13. The computer-readable storage medium, of claim 9, further comprising:
instructions executable by at least one processing device that, when executed, cause the processing device to receive funds from the point-of-sale terminal via a centralized controlling entity, wherein the centralized controlling entity serves as a transaction hub for a plurality of point-of-sale terminals.

14. A method of facilitating a transaction, the method comprising:
(a) tokenizing a transaction by linking one or more transaction instructions a token ID;
(b) providing an end-user with the token ID;
(c) receiving confirmation that the end-user has presented, to a point-of-sale terminal, the token ID and a payment in accordance with the one or more transaction instructions;
(d) notifying a merchant-partner that the end-user has provided the payment to the point-of-sale terminal; and
(e) settling the transaction between the point-of-sale terminal and the merchant-partner by (1) creating a funding record identifying a funding amount expected to be received from the point-of-sale terminal, (2) receiving funds from the point-of-sale terminal, (3) confirming that the funds received in step (2) match the funding amount expected from step (1), and (4) generating an outbound cash-flow to the merchant-partner to settle the transaction.

15. The method of claim 14, wherein step (4) is performed only after step (3).

16. The method of claim 14, wherein after step (c), the method further comprises:
asserting to the merchant-partner what amount is owed to the merchant-partner.

17. The method of claim 16, further comprising:
asserting to the merchant-partner when the amount owed will be released to the merchant-partner.

18. The method of claim 14, wherein step (e) further comprises:
receiving a line-item detail file from the point-of-sale terminal; and
reconciling the line-item detail file with the created funding record.

19. The method of claim 18, wherein the line-item detail file is a non-chronological database of point-of-sale terminal transactions.

20. The method of claim 14, wherein step (e)(2) comprises:
receiving funds from the point-of-sale terminal via a centralized controlling entity, wherein the centralized controlling entity serves as a transaction hub for a plurality of point-of-sale terminals.
